(19) United States
(12) Patent Application Publication
(10) Pub. No.: US 2009/0096617 A1
(43) Pub. Date: Apr. 16, 2009

(54) SYSTEM AND METHOD FOR MONITORING FOOD TEMPERATURE IN FOOD SERVICE EQUIPMENT

(75) Inventors: Michael S. Purcell, Wappingers Falls, NY (US); Martin E. Madden, Newtown, CT (US)

Correspondence Address: FOLEY & LARDNER LLP, 777 EAST WISCONSIN AVENUE, MILWAUKEE, WI, 53202-5306, US

(73) Assignee: Multiteria, LLC

(21) Appl. No.: 12/248,792

(22) Filed: Oct. 9, 2008

Related U.S. Application Data
(60) Provisional application No. 60/998,415, filed on Oct. 10, 2007.

(51) Int. Cl. G08B 21/00

(52) U.S. Cl. 340/584

(57) ABSTRACT

A system for monitoring the temperature of food in food serving equipment. The system includes a detection unit incorporating a sensor, a transmitter, and a probe. The system further includes a display unit having a receiver and an operator interface. The probe is at least partially inserted into the food so that the temperature of the food is detected by the sensor and wirelessly transmitted to the receiver to be displayed on the operator interface.

### CROSS-REFERENCE TO RELATED PATENT APPLICATIONS

This application claims priority to and the benefit of U.S. Provisional Patent Application 60/998,415, filed Oct. 10, 2007, which is incorporated herein by reference in its entirety.

### BACKGROUND

The present invention relates to a system and method for detecting and monitoring food temperature. Measuring and monitoring the temperature of food is important to providing a consistent quality of food, food safety, and reducing outbreaks of food borne illness. Known methods of measuring and monitoring food temperature requires regular insertion of a thermometer.

It is generally known to provide equipment to serve and/or store heated or cooled food, such as for displaying, serving, and/or transporting. Such food serving equipment typically includes one or more receptacles that receive food pans and may be filled with water to heat the food pans (e.g., with steam and commonly referred to as a “hot well”) or cool the food pans (e.g. with mechanical refrigeration or ice and commonly referred to as a “cold pan”). Such food serving equipment typically also includes controls for controlling the temperature of receptacles, and a shield configured to provide a barrier between people and food located in the receptacles.

Accordingly, it would be advantageous to provide a system and method to remotely measure and monitor food temperature in the food serving equipment. If food temperature is out of a specified range, a person, or automated equipment, can immediately remedy the situation. To provide an inexpensive, reliable, and widely adaptable system and method for detecting and monitoring food temperature would represent a significant advance in the art.

### SUMMARY

One embodiment of the invention relates to a system for monitoring the temperature of food in food serving equipment. The system includes a detection unit incorporating a sensor, a transmitter, and a probe. The system further includes a display unit having a receiver and an operator interface. The probe is at least partially inserted into the food so that the temperature of the food is detected by the sensor and wirelessly transmitted to the receiver to be displayed on the operator interface.

Another embodiment of the invention relates to a system for monitoring the temperature of food in food serving equipment. The system includes a detection unit incorporating a first sensor, a transmitter, and a probe. The system further includes a second sensor coupled to a food receptacle of the food serving equipment and configured to detect an input temperature. The system still further includes a display unit having a receiver and an operator interface. The probe is at least partially inserted into the food so that the temperature of the food is detected by the first sensor and wirelessly transmitted to the receiver to be displayed on the operator interface. The input temperature is preferably displayed on the operator interface simultaneously with the temperature of the food.

Another embodiment of the invention relates to a method for monitoring the temperature of food in food serving equipment. The method includes providing a detection unit incorporating a first sensor, a transmitter, and a probe. The method further includes providing a second sensor that is coupled to a food receptacle of the food serving equipment. The method still further includes providing a display unit having a receiver and an operator interface. The temperature of the food is detected with the first sensor. An input temperature is detected with the second sensor. The temperature of the food and the input temperature are displayed simultaneously on the operator interface.

Another embodiment of the invention relates to a system for monitoring the temperature of food in food serving equipment. The system includes a detection unit incorporating an infrared sensor coupled to the food serving equipment. The system further includes a display unit that is coupled to the detection unit and includes an operator interface. The surface temperature of the food is remotely detected by the infrared sensor and displayed on the operator interface.

The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### BRIEF DESCRIPTION OF THE FIGURES

FIG. 1 is an isometric view of food serving equipment that includes a temperature monitoring system according to an exemplary embodiment.

FIG. 2 is an isometric view of a receptacle for the food serving equipment of FIG. 1.

FIG. 3 is a front elevation view of a detection unit for the temperature monitoring system of FIG. 1. according to an exemplary embodiment.

FIG. 4 is a side view of the detection unit of FIG. 3.

FIGS. 5A through 5E are isometric views of various garnish replicas used to cover, disguise, or hide the detection unit of FIG. 3.

FIG. 6 is an isometric view of a display unit of the temperature monitoring system of FIG. 1 according to an exemplary embodiment.

FIG. 7 is an isometric view of food serving equipment that includes a temperature monitoring system according to another exemplary embodiment.

FIG. 8 is an isometric view of a receptacle for the food serving equipment of FIG. 7.

### DETAILED DESCRIPTION

Before explaining a number of preferred, exemplary, and alternative embodiments of the invention in detail it is to be understood that the invention is not limited to the details of construction and the arrangement of the components set forth in the following description or illustrated in the drawings. The invention is capable of other embodiments or being practiced or carried out in various ways. It is also to be understood that the phraseology and terminology employed herein is for the purpose of description and should not be regarded as limiting.

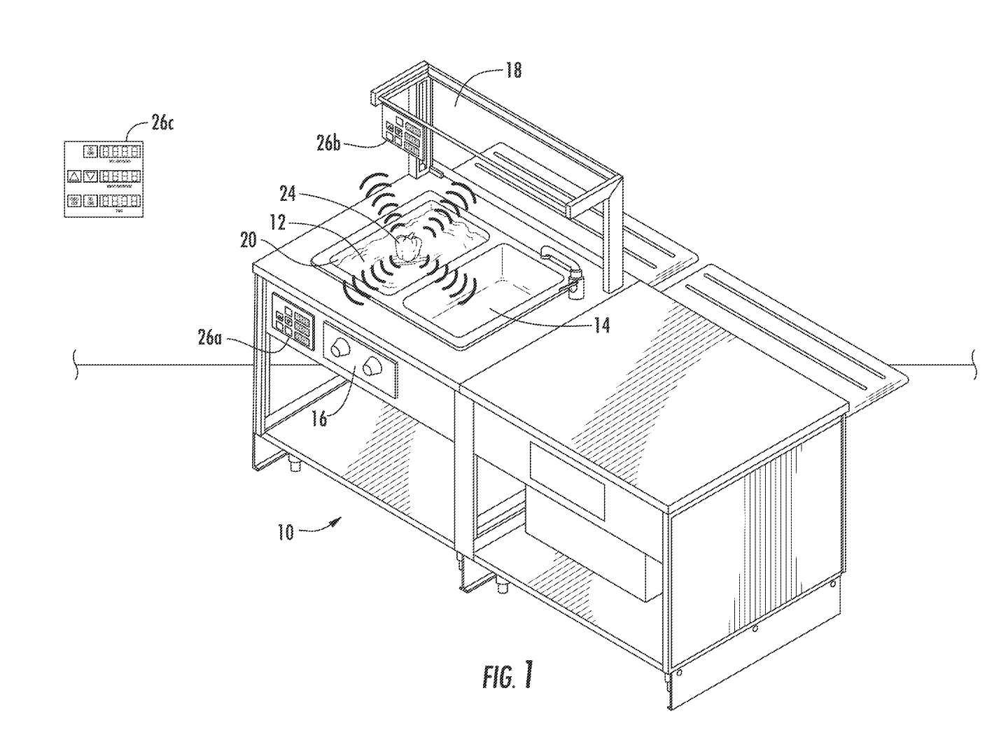

FIG. 1 shows food serving equipment 10 for displaying, serving, and/or transporting food 12 (e.g., in a cafeteria, restaurant, or the like). The food serving equipment 10 includes one or more receptacles 14, an optional control interface 16 for controlling the temperature of the receptacles 14 (via a heating element that is not shown), and a shield or guard 18 configured to provide a barrier between people and the food 12 located in the receptacles 14.

The receptacles 14 are configured to receive food pans 20 and the receptacles 14 may or may not be filled with water and/or ice to aid in the heating and/or cooling of the food pans 20. The receptacles 14 may heat the food pans 20 by any of a variety of heating elements or methods (e.g., Calrod, heat blanket, etc.). When used for heating, the receptacles 14 are commonly referred to as “hot wells.” Alternatively, the receptacles 14 may cool food pans 20 by any of a variety of cooling methods (e.g., the receptacles 20 may be filled with ice or cooled by mechanical refrigeration).

FIG. 1 also shows a temperature monitoring system 22 that is provided to assist in monitoring the temperature of the food 12 within the food pans 20. The temperature monitoring system 22 includes a detection unit 24 and a display unit 26. The display unit 26 may be located in various locations, such as coupled to the food serving equipment 10 (e.g., as shown by display unit 26a), coupled to the guard 18 (e.g., as shown by display unit 26b), or coupled to a nearby wall or surface (e.g., as shown by display unit 26c).

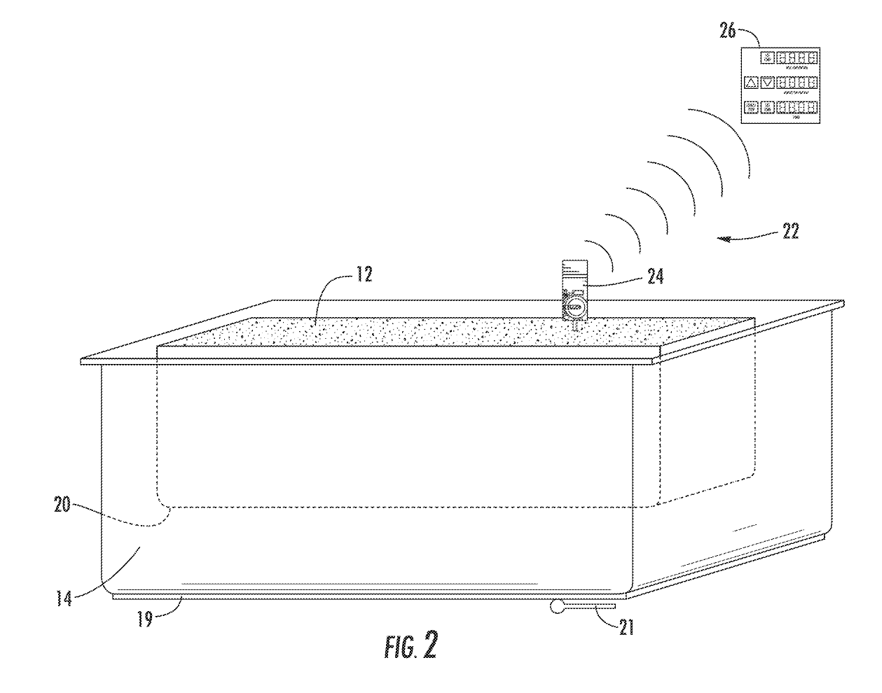

FIG. 2 shows the receptacle 14 with a heating element 19 configured to heat the food pan 20. A temperature sensor 21 is provided on the receptacle 14 to detect (e.g., measure, sense, etc.) the temperature (referred to as the input temperature) of the receptacle 14. The input temperature may be displayed on the display unit 26. The temperature sensor 21 is conductively coupled to the receptacle 14 and may be physically conductively coupled to the display unit 26 through the use of a conventional wire or may wirelessly transmit the input temperature to be displayed to the display unit 26.

As shown in FIG. 2, a detection unit 24 is provided (e.g., placed, inserted, etc.) in food 12. The detection unit 24 detects (e.g., measures, senses, etc.) the temperature of food 12 and wirelessly transmits the food temperature so that it may be displayed on the display unit 26. Perhaps the most important factor in food service is the actual temperature of the food product while it is being served. Therefore, the detection unit 24 is utilized to obtain an accurate temperature of the food 12, not just of the input temperature of the receptacle 14. At least a portion of the detection unit 24 is below the surface of the food 12, enabling the detection unit 24 to detect an accurate temperature of the food 12. The detection unit 24 may be used in multiple food pans 20. Additionally, multiple detection units 24 may be used with a single display unit 26.

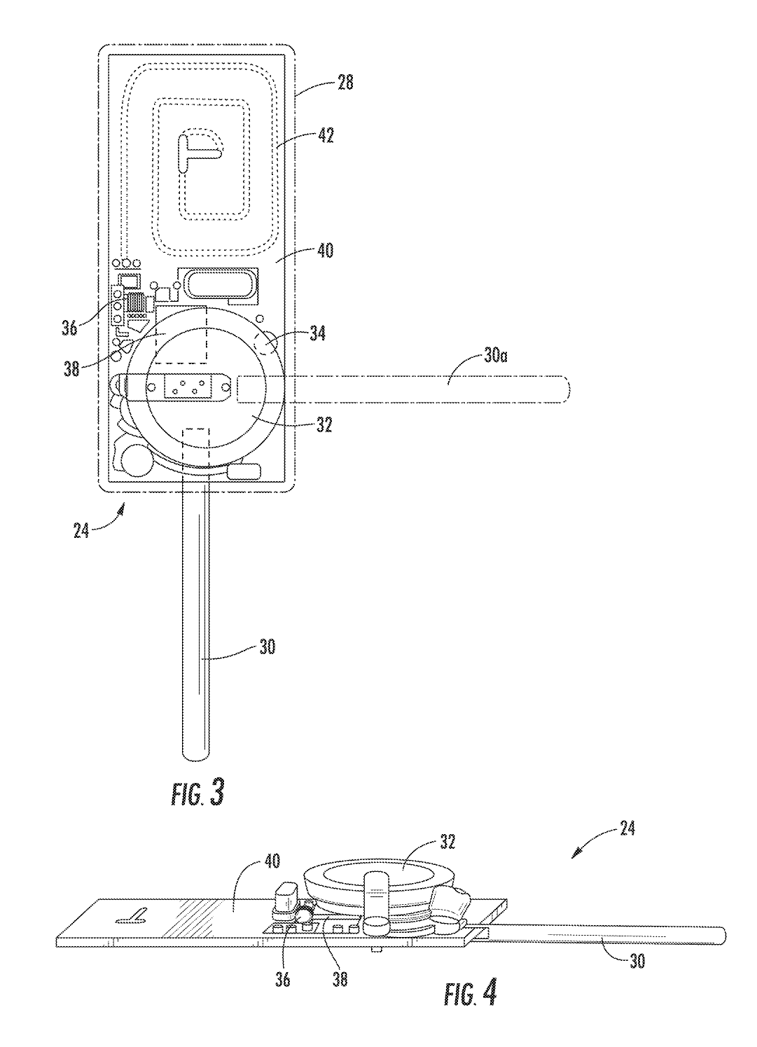

FIGS. 3-4 show a detection unit 24 according to one exemplary embodiment. The detection unit 24 includes a probe 30, a battery 32, a sensor 34, a transmitter 36, and a microcontroller 38. As shown in the Figures, the probe 30 extends from one end of the detection unit 24. According to an exemplary embodiment, the probe 30 extends in a linear manner with respect to the detection unit 24. According to an alternative embodiment, the probe 30 extends perpendicular to the detection unit 24, as shown by the position of the probe 30a in FIG. 3. The probe 30 is preferably made from a heat conductive material (e.g., aluminum, stainless steel, etc.) to rapidly heat/cool to the temperature of the food 12. The probe 30 is shown as a linear or straight member, but may be any of a variety of shapes, sizes, or the like. According to an exemplary embodiment, the probe 30 extends from the main body of the detection unit 24 about 1 inch (but may extend shorter or longer from the detection unit 24 according to various embodiments).

The probe 30, battery 32, sensor 34, transmitter 36, and microcontroller 38 are mounted on a circuit board 40. The battery 32 provides power to the transmitter 36, sensor 34, and microcontroller 38. The sensor 34 measures the temperature of the probe 30 when the probe 30 is inserted into the food 12. The microcontroller 38 may comprise a central processing unit (CPU), memory, inputs, outputs, and resident software. The microcontroller 38 controls the functions of the detection unit 24, including converting the measured temperature into data that is then transmitted by the transmitter 36.

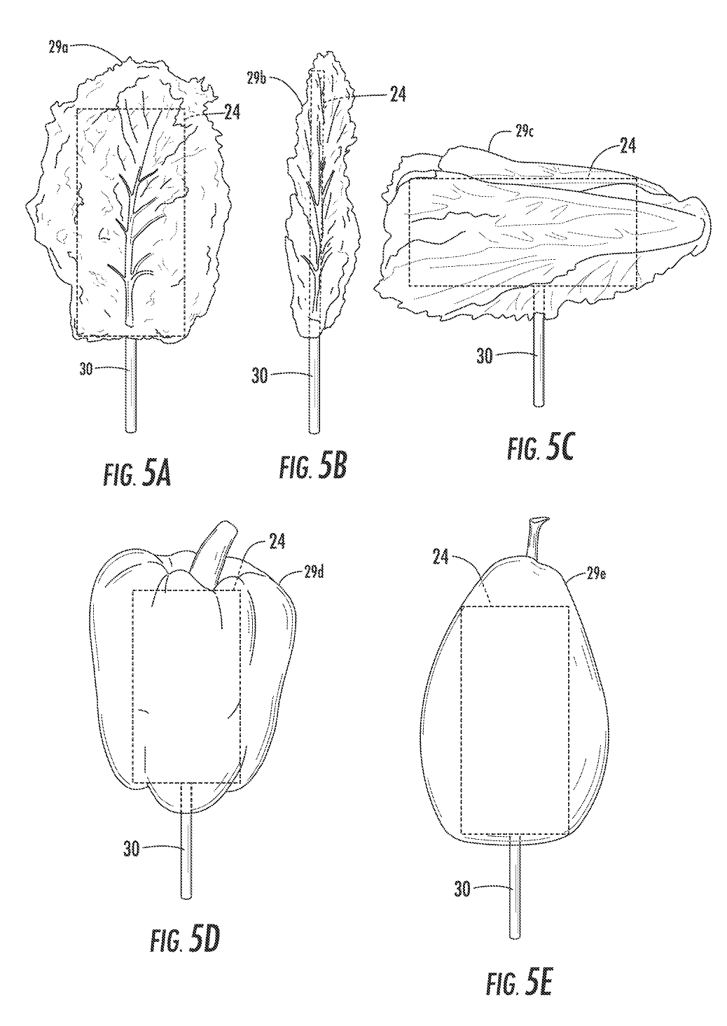

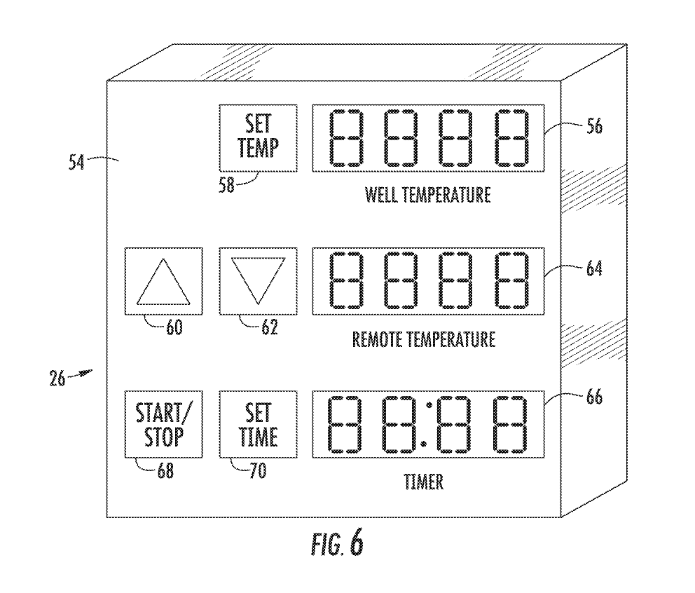

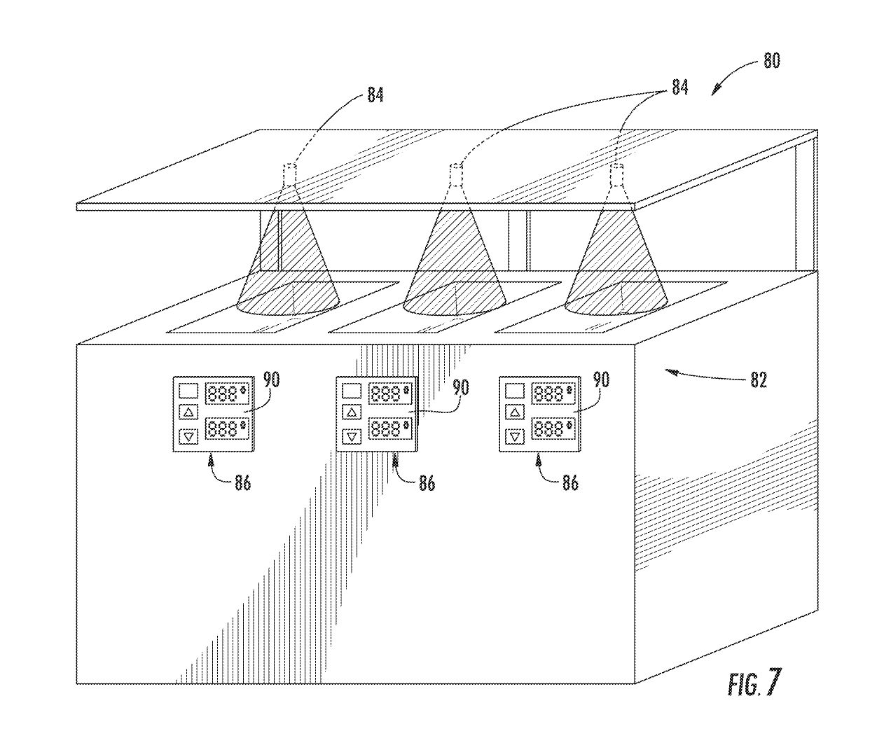

According to an exemplary embodiment, the battery 32, circuit board 40, transmitter 36, sensor 34, microcontroller 38, and a portion of the probe 30 are encapsulated by an epoxy (e.g., an FDA approved epoxy or a thermosetting material) to protect the components of the detection unit 24 and maintain food safety. When inserted into the food 12, the detection unit 24 may be at least partially hidden by a replica food item 29 (e.g., a garnish such as lettuce, a pepper, a pear, etc.), such as shown in FIGS. 5A-5E.

The detection unit 24 may be placed underneath the food item 29, in between layers of the food item 29, or may be inserted in a cavity of the food item 29. According to an alternative embodiment, an optional housing 28 (as shown in FIG. 3) may be provided around the detection unit 24. According to an exemplary embodiment, the housing 28 is provided in the shape of a food item (e.g., a garnish such as lettuce, a pepper, a pear, etc.). According to an exemplary embodiment, the food item is made from a food safe plastic. According to another exemplary embodiment, the food item is lightweight so as to not sink when placed in the food 12.

According to an exemplary embodiment, the detection unit 24 transmits a single, three-byte data transmission packet. The first byte contains a sensor identification number, a second byte contains the measured temperature, and a third byte is the binary complement of the identification number to ensure transmission integrity. According to an exemplary embodiment, the bandpass signaling technique is Amplitude Shift Keying (ASK). To conserve battery life, the microcontroller 38 cycles the detection unit 24 between a sleep mode and an awake mode. For example, at predetermined intervals (e.g., every 5 seconds, 10 seconds, 20 seconds, 30 seconds, etc.), the microcontroller 38 turns the transmitter 36 on, enables the sensor 34 to detect the temperature of the probe 30, and transmits the identification and the detected temperature before going into a sleep mode again. When several detection units 24 are used (e.g., for adjacent food serving equipment 10 or receptacles 14), the identification number serves to ensure that the temperature for food pan 20 is displayed on the proper display unit.

According to an exemplary embodiment, the transmitter 36 includes an antenna 42 (as shown in FIG. 3) and operates at 315 MHz or 433 MHz. The antenna 42 may be a loop antenna or printed on a circuit board 40. Alternatively, any of a variety of antennas may be used depending on the desired configuration and the desired range.

FIG. 6 shows a display unit 26 according to an exemplary embodiment. The display unit 26 includes an operator interface 54, a receiver (not shown), and a microcontroller (not shown) having resident software. The receiver receives the data packet from the transmitter 36 of the detection unit 24. The receiver is configured to disregard a transmission packet if the second byte of information is not received within a predetermined amount of time (e.g., 0.1 to 0.3 seconds). The microcontroller receives the radio frequency (RF) transmission from the transmitter 36, compares the identification number with its own, and displays the temperature (e.g., on operator interface 54) when they match. If no temperature data is received in some period of time (e.g., 20 seconds) display unit 26 will indicate “no signal” on the display with dashes, blanks, or the like.

The display unit 26 may be mounted on food serving equipment 10 (e.g., below the counter, to the shelf, on a wall, or the like). A secondary display unit 26c may be provided so that temperature monitoring can be done from several locations (e.g., at the food serving equipment, at a manager's or supervisor's office, or elsewhere). The display unit 26 may also be provided in a portable device for additional flexibility or the ability to move from equipment to equipment to check food temperature. According to an exemplary embodiment, the monitoring may include internal memory or may be in communication with a computer so that food temperature is recorded and can be retrieved at a later point in time. According to an exemplary embodiment, the display unit 26 is powered by line voltage. Alternatively, the display unit 26 may be powered by a battery.

Still referring to FIG. 6, the operator interface 54 of the display unit 26 is configured to input and display various information. The display unit 26 displays the input temperature of the receptacle 14 measured by sensor 21 on the operator interface 54. The display unit 26 also displays the food temperature measured by the detection unit 24 on the operator interface 54. Additionally, the display unit 26 may be configured to display the temperature from a single detection unit 24, or from a plurality of detection units 24 (e.g., with multiple displays, a cycling display, etc.).

The operator interface 54 is shown as a five switch membrane panel with three four-digit numeric displays. The first numeric display 56 displays the input (or hot well) temperature for the food product (e.g. measured by sensor 21), and is set by pressing the “SET TEMP” button 58 and then the arrow keys 60, 62 until the desired temperature is shown in the first numeric display 56. The second numeric display 64 is for the measured temperature of the detector unit 24 (representative of the food product temperature). The third numeric display 66 is a programmable timer, which is started/stopped by the “START/STOP” button 68 and set by pressing the “SET TIME” button 70 and the up and down arrow keys 60, 62. The programmable timer may be used to show the elapsed time that the food 12 has been in the food serving equipment 1O. According to alternative embodiments, the operator interface may have any of a variety of layouts, buttons, and displays.

In operation, the probe 30 is at least partially inserted into the food 12 within the food pan 20. The sensor 34 detects the temperature of the probe 30, which is representative of the temperature of the food 12 in the food pan 20. The transmitter 36 wirelessly transmits the measured temperature of the food 12, which is received by the receiver 50 of the display unit 26. The operator interface 54 displays the food temperature in the numeric display 64. The operator interface 54 also simultaneously displays the input temperature of the receptacle 14 as measured by sensor 21.

If the measured temperature of the food is outside an input or specified range, an alarm may sound and/or lights may be illuminated to inform the operator, supervisor, etc. to take the appropriate action. According to an exemplary embodiment, the microcontroller of the display unit 26 may automatically modify the heat being provided to the receptacle 14 until the food temperature is within the specified range. Alternatively, the heater may be controlled by inputting the set temperature (through push button controls) using operator interface 54 or through conventional knobs/dials of control interface 16.

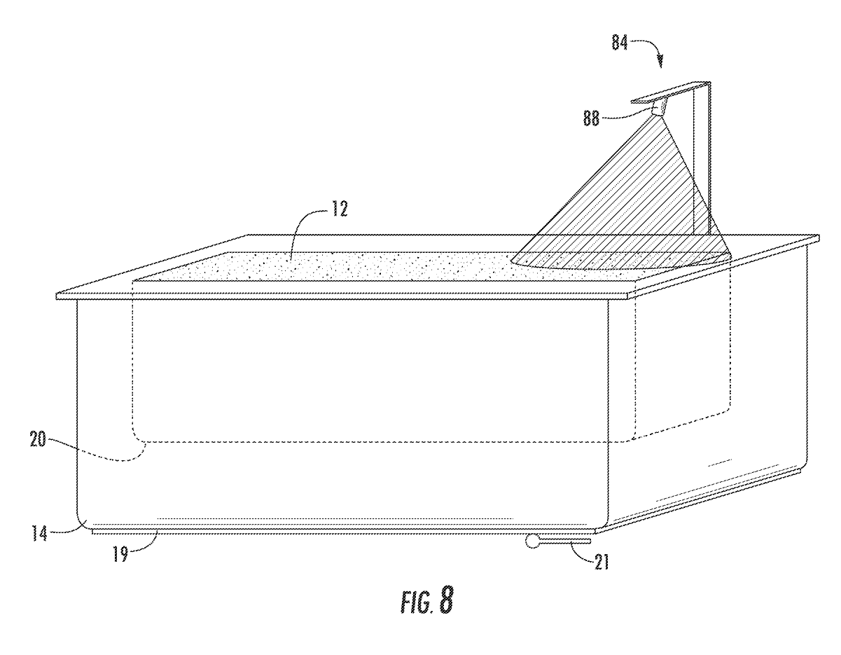

Referring to FIGS. 7-8, food serving equipment 80 includes a temperature monitoring system 82 according to an alternative embodiment. The temperature monitoring system 82 includes a detection unit 84 and a display unit 86. The detection unit 84 includes a food temperature sensor 88 to measure the surface temperature of food 12 within the food pan 20. A controller 90 in the display unit 86 receives signals from a well temperature sensor 21 and food temperature sensor 88, and displays the two temperatures on the display unit 86. The controller 90 also controls the heat output of the heater based on the temperature sensed by input temperature sensor 21.

According to an exemplary embodiment, the food temperature sensor 88 (e.g., an infrared or IR sensor) is mounted above the food pan 20 (e.g., on a post, on a glass shelf, on a sneeze/breath guard, etc.) and directed to the food product 12. The food temperature sensor 88 may be used to only provide a temperature measurement of the food (i.e., an indicator that does not control the heater) or may provide an input to the controller to adjust the heater. The display unit 86 may be similar to the display unit 26 of the previous embodiment.

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. Such joining may also relate to mechanical, fluid, or electrical relationship between the two components.

It is also important to note that the construction and arrangement of the elements of the system and method for detecting and monitoring food temperature as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as expressed in the appended claims.

What is claimed is:

1. A system for monitoring the temperature of food in food serving equipment, the system comprising:
a detection unit comprising a sensor, a transmitter, and a probe;
a display unit comprising a receiver and an operator interface;
wherein the probe is at least partially inserted into the food so that the temperature of the food is detected by the sensor and wirelessly transmitted to the receiver to be displayed on the operator interface.

2. The system of claim 1, further comprising a second sensor coupled to a food receptacle of the food serving equipment and configured to detect an input temperature, wherein the input temperature is displayed on the operator interface simultaneously with the temperature of the food.

3. The system of claim 1, wherein the sensor, the transmitter, and at least a portion of the probe are encapsulated to shield the sensor, transmitter, and at least a portion of the probe from the environment.

4. The system of claim 3, wherein the sensor, the transmitter, and portion of the probe are at least partially hidden by a replica garnish.

5. The system of claim 4, wherein the replica garnish resembles at least one of a lettuce, a pepper, and a pear.

6. The system of claim 3, wherein the sensor, the transmitter, and at least a portion of the probe are encapsulated by at least one of a food grade epoxy and a housing.

7. The system of claim 6, wherein the housing is shaped to resemble a garnish.

8. A system for monitoring the temperature of food in food serving equipment, the system comprising:
a detection unit comprising a first sensor, a transmitter, and a probe;
a second sensor coupled to a food receptacle of the food serving equipment and configured to detect an input temperature; and
a display unit comprising a receiver and an operator interface;
wherein the probe is at least partially inserted into the food so that the temperature of the food is detected by the first sensor and wirelessly transmitted to the receiver to be displayed on the operator interface; and
wherein the input temperature is displayed on the operator interface simultaneously with the temperature of the food.

9. The system of claim 8, wherein the first sensor, the transmitter, and at least a portion of the probe are encapsulated by at least one of a food grade epoxy and a housing.

10. The system of claim 9, wherein the first sensor, the transmitter, and portion of the probe are at least partially hidden by a replica garnish.

11. The system of claim 8, wherein the input temperature is adjusted based upon the temperature of the food detected by the first sensor.

12. The system of claim 11, wherein the input temperature is adjusted automatically.

13. The system of claim 8, wherein an alarm occurs if the temperature of the food falls outside a specified range.

14. The system of claim 13, wherein the alarm is at least one of an audible alarm and a visual alarm.

15. A method for monitoring the temperature of food in food serving equipment, the method comprising:
providing a detection unit comprising a first sensor, a transmitter, and a probe;
providing a second sensor coupled to a food receptacle of the food serving equipment;
providing a display unit comprising a receiver and an operator interface;
detecting the temperature of the food with the first sensor; and
detecting an input temperature with the second sensor;
wherein the temperature of the food and the input temperature are displayed simultaneously on the operator interface.

16. The method of claim 15, wherein the probe of the detection unit is at least partially inserted into the food so that the temperature of the food is detected by the first sensor and wirelessly transmitted to the receiver to be displayed on the operator interface.

17. The method of claim 15, wherein the first sensor, the transmitter, and at least a portion of the probe are encapsulated and are at least partially hidden by a replica garnish.

18. The method of claim 17, wherein the replica garnish resembles at least one of a lettuce, a pepper, and a pear.

19. The method of claim 17, wherein the first sensor, the transmitter, and at least a portion of the probe are encapsulated by at least one of a food grade epoxy and a housing shaped as a replica garnish.

20. The method of claim 17, further comprising the step of controlling the input temperature based upon the temperature of the food measured by the first sensor.

21. A system for monitoring the temperature of food in food serving equipment, the system comprising:
a detection unit comprising an infrared sensor coupled to the food serving equipment;
a display unit coupled to the detection unit and comprising an operator interface;
wherein surface temperature of the food is remotely detected by the infrared sensor and displayed on the operator interface.

22. The system of claim 21, wherein the infrared sensor is coupled on a shelf or a breath guard coupled to the food serving equipment.
